(19) United States
(12) Patent Application Publication
(10) Pub. No.: US 2008/0267007 A1
(43) Pub. Date: Oct. 30, 2008

(54) Device for Mixing or Amalgamating Products in Liquid, Granular or Powder Form

(75) Inventors: Gian Marco Bressani, Hong Kong (HK); Soo Chuan Chng, Singapore (SG)

Correspondence Address: MERCHANT & GOULD PC, P.O. BOX 2903, MINNEAPOLIS, MN, 55402-0903, US

(73) Assignee: STARDALE LTD., Wanchai (CN)

(21) Appl. No.: 12/089,407

(22) PCT Filed: Oct. 10, 2006
(86) PCT No.: PCT/IB06/53709

§ 371 Date: Apr. 7, 2008

(30) Foreign Application Priority Data
Oct. 12, 2005 (IT) TO2005A000726

(51) Int. Cl. B01F 11/00; B01F 9/00

(52) U.S. Cl. 366/211; 366/237

(57) ABSTRACT

The device (10) comprises a substantially stationary outer frame (14) and a movable inner frame (18) supported by the outer frame (14). The inner frame (18) is provided with a lower support plate (26) for a receptacle (C) containing the product to be mixed and with an upper clamping plate (30) which can be moved towards the inner plate (26) to clamp the receptacle (C). The lower and upper plates (26, 30) are both rotatably mounted about a vertical axis (Z). The device comprises a first electric motor (32), first driving means (38, 40, 42, 44, 45) arranged to impart a vertical oscillation movement to the receptacle (C) and second driving means (38, 40, 42, 58, 60, 56, 54, 52, 48, 26) arranged to impart a rotational movement about a vertical axis (Z) to the receptacle (C) at the same time as the vertical oscillation movement. The first and second driving means are both operated by the first electric motor (32).

The present invention refers to a device for mixing or amalgamating products in liquid, granular or powder form, such as paints, seeds and the like, as set forth in the preamble of claim 1.

Mixing devices generally known under the name of “shakers” have been present on the market for a long time, which devices are arranged to impart a vertical oscillation movement to a receptacle containing the product to be mixed.

A mixing device of the above-identified type is known for instance from U.S. Pat. No. 4,134,689, from which FIG. 8 of the attached drawings is taken. With reference to FIG. 8, the mixing device known from the aforesaid patent comprises an outer frame 1 resting on the ground, an intermediate frame 2 supported by the outer frame 1 by means of springs 3 and an inner frame 7. A motor M2 and a horizontal drive shaft 4 which is operated by the motor M2 through a belt transmission 8 are mounted in the lower part of the intermediate frame 2. The drive shaft 4 is provided at its opposite ends with two eccentric pins 6 connected to the inner frame 7. Moreover, an eccentric mass 30 is secured to the drive shaft 4 and is offset 180 degrees relative to the eccentric pins 6. The inner frame 7 has a support base 10 on which one or more receptacles 11 with the product(s) to be mixed can be placed. In this way, upon operation of the motor M2 the inner frame 10 is subjected to a vertical oscillation movement along an approximately oval or elliptic path. In order to clamp the receptacle(s) 11 against the support base 10, the inner frame 7 also carries a clamping plate 12 which can be displaced vertically by means of a worm and nut screw driving mechanism 13, 14 operated by an electric motor M1 mounted on the intermediate frame 2. More specifically, the driving mechanism for the clamping plate 12 comprises a pair of nut screws 13 secured to the sides of the clamping plate 12 and a pair of worms 14 each meshing with a respective nut screw 13. The worms 14 are rotatably mounted on the inner frame 7 and carry and their upper ends respective pulleys 18 on which a belt 19 is wound. One of the worms 14 (the one on the right in the illustrated example) is connected to a vertical output shaft 20 of an angle gear box 21. A horizontal input shaft 22 of the angle gear box 21 is connected to an output shaft 26 of the electric motor M1. In this way, upon operation of the motor M1 the clamping plate 12 can be displaced vertically to clamp or release the receptacle 11.

The above-discussed mixing device is however not very suitable for mixing high-viscosity or high-density products, such as for example stucco, lime and the like, since the simple vertical oscillation movement imparted to the receptacle is not able in this case to bring about an efficient mixing action. Gyroscopic mixers would rather be necessary for mixing high-viscosity or high-density products.

The above-discussed mixing device is also not very ergonomic, since it requires the user to place manually the receptacle with the product to be mixed on the support base within the device, which operation may turn out to be quite difficult in particular with very bulky and/or heavy receptacles.

It is therefore the object of the present invention to obviate the shortcomings of the above-discussed prior art, providing a mixing device which is able to perform an efficient and quick mixing action on all the kinds of products, also on high-viscosity and/or high-density products, without thereby making the structure of the device too complicated and increasing too much the costs of the device. A further object of the invention is to provide a mixing device which is easy to use, even when very bulky and/or heavy receptacles have to be handled.

These and other objects are fully achieved according to the present invention by virtue of a device for mixing or amalgamating products in liquid, granular or powder form having the characteristics set forth in the characterizing portion of claim 1.

Further advantageous characteristics of the device of the invention are set forth in the dependent claims.

In short, the invention is based on the idea of providing a mixing device of the type set forth in the introductory part of the description, in which a driving mechanism for imparting a rotational movement to the receptacle about a vertical axis is also provided and in which this driving mechanism is arranged to be operated by the same motor as the one which operates the driving mechanism for imparting the vertical oscillation movement to the receptacle. Since a simultaneous rotational movement of the receptacle about a vertical axis is added to the vertical oscillation movement of the receptacle, the advantage of making the mixing action more efficient is clearly achieved. The time required to perform the mixing operation can thus be reduced for the same product to be mixed.

According to a further aspect of the invention, the mixing device is provided with a lower support plate for the receptacle(s) mounted in such a manner that it can be pulled out to allow the user easily to place and pull out the receptacle, which is very useful particularly in case of very bulky and/or heavy receptacles.

Further characteristics and advantages of the invention will result from the detailed description which follows, given purely by way of non-limiting example with reference to the appended drawings, in which:

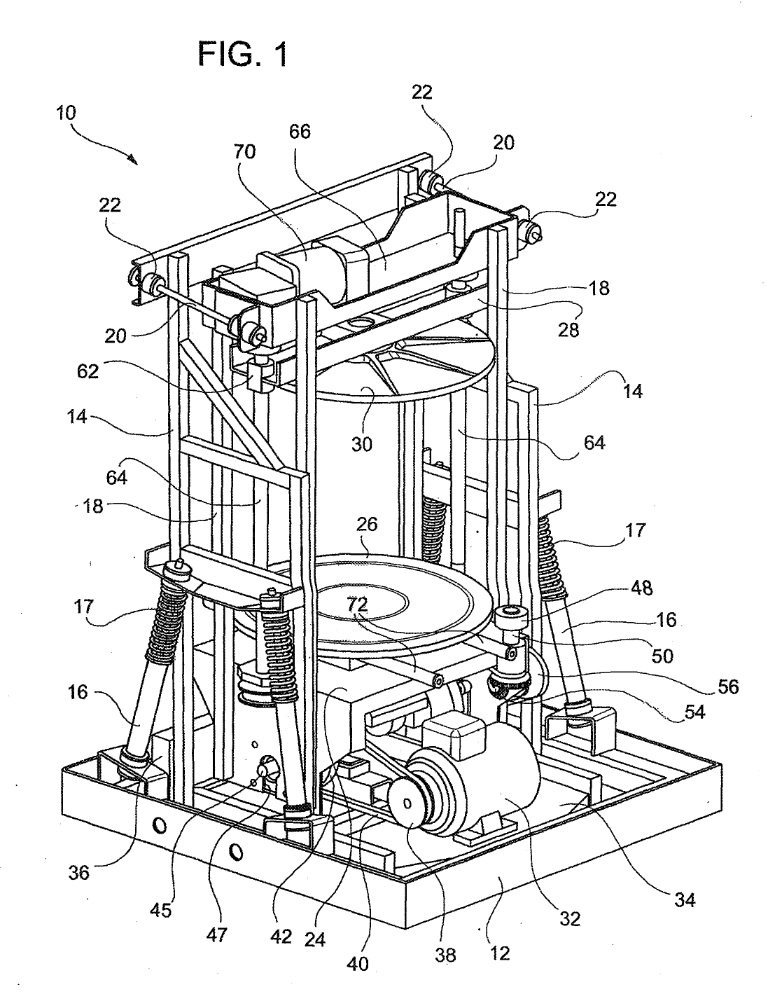

FIG. 1 is a rear perspective view, taken from the right, of a mixing device according to a preferred embodiment of the present invention, in the normal operating condition (in which the lower support plate is retracted);

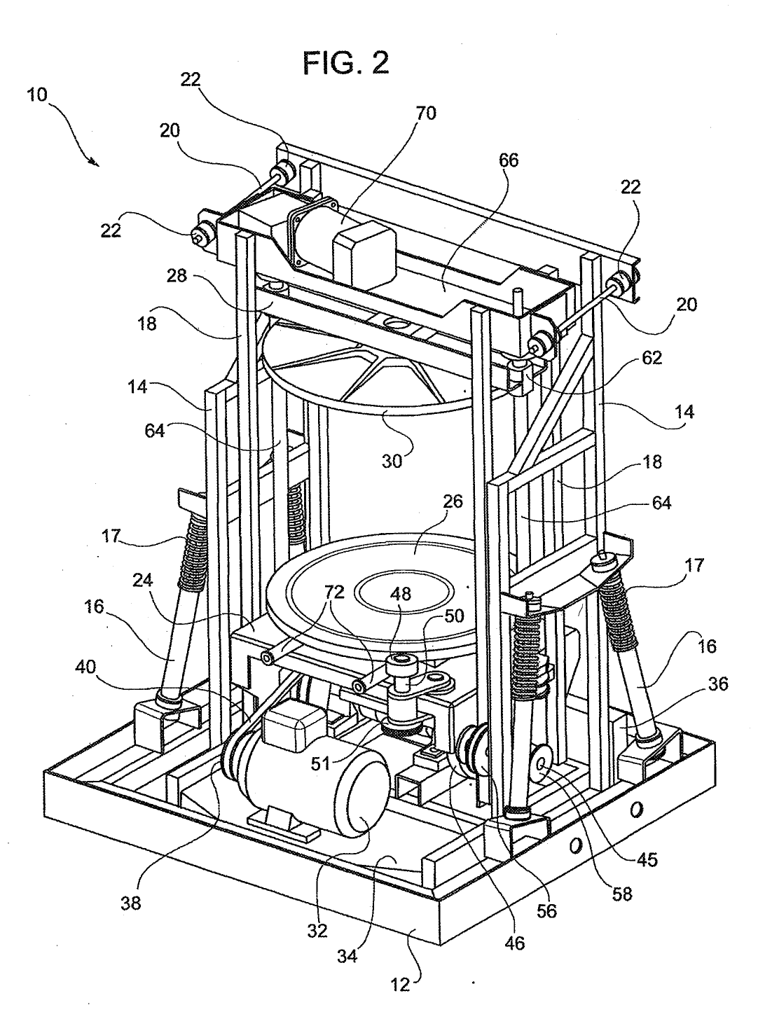

FIG. 2 is a further rear perspective view, taken from the left, of the mixing device of the invention in the same condition as FIG. 1;

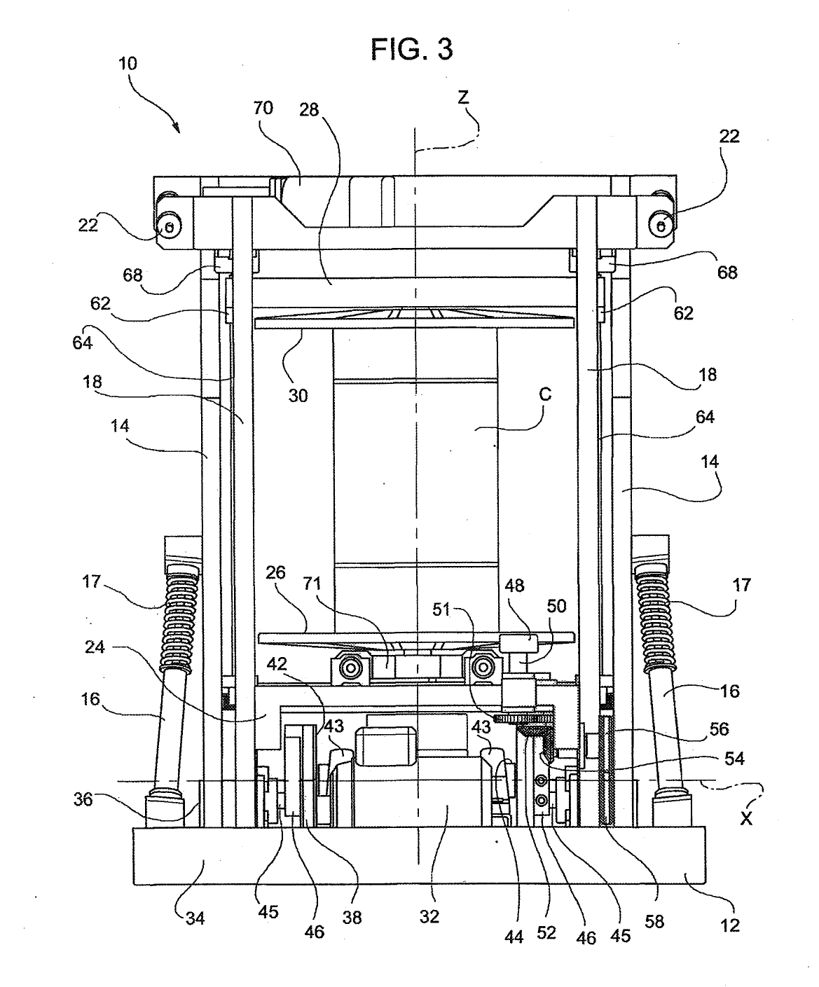

FIG. 3 is a rear elevation view of the mixing device of the invention in the same condition as FIG. 1;

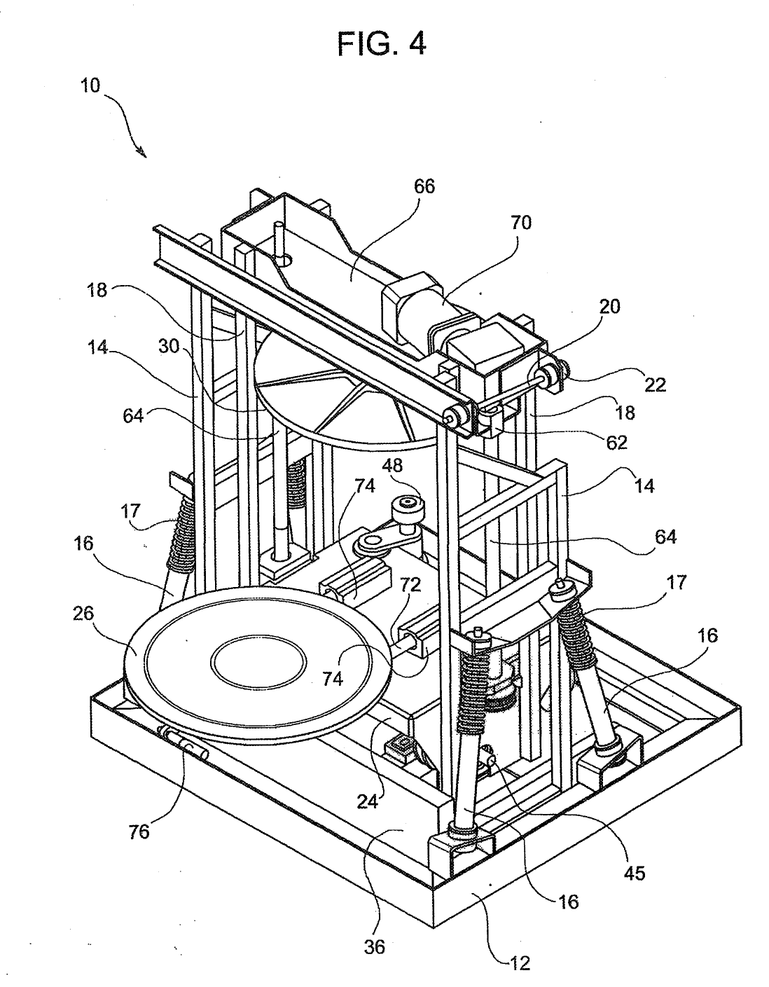

FIG. 4 is a front perspective view, taken from the right, of the mixing device of the invention, in the loading/unloading condition (in which the lower support plate is pulled out);

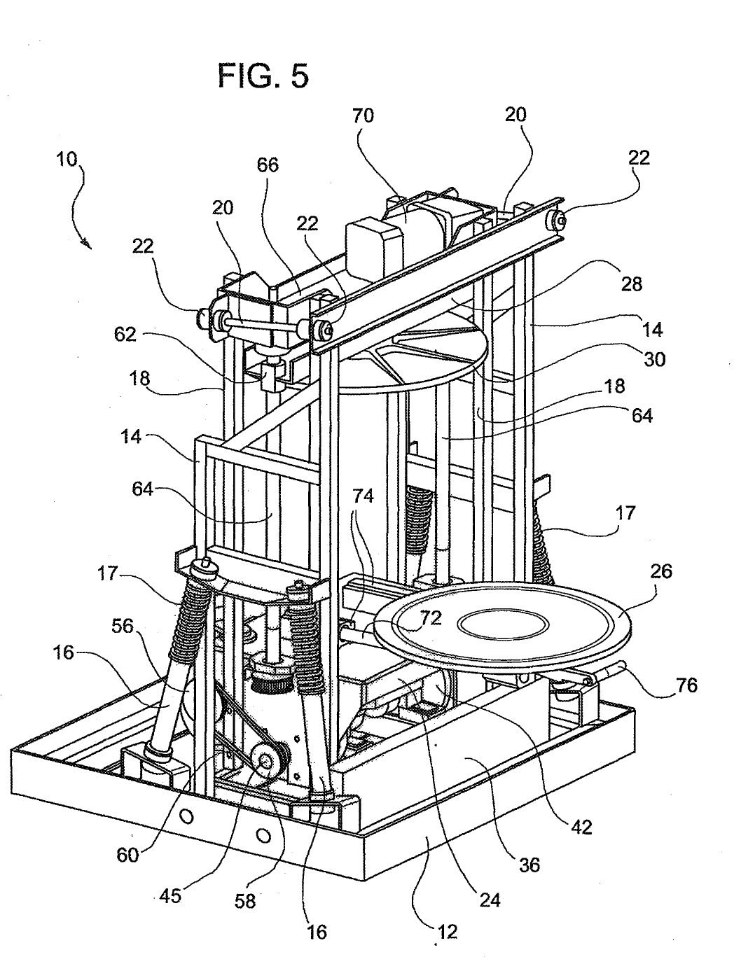

FIG. 5 is a further front perspective view, taken from the left, of the mixing device of the invention, in the same condition as FIG. 4;

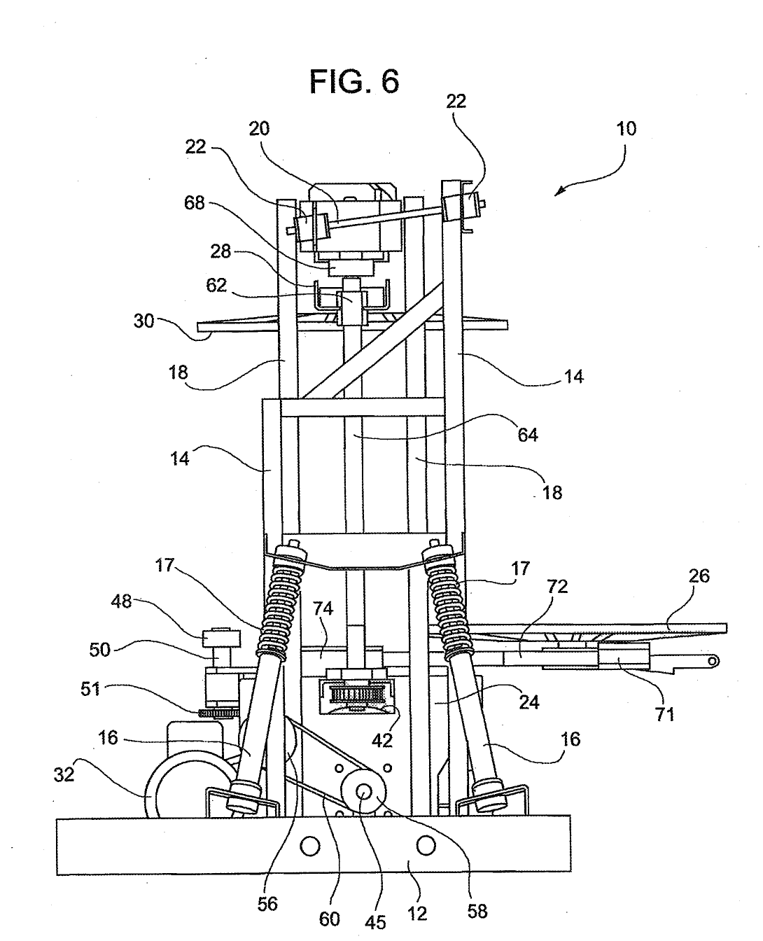

FIG. 6 is a side elevation view of the mixing device of the invention, in the same condition as FIG. 4;

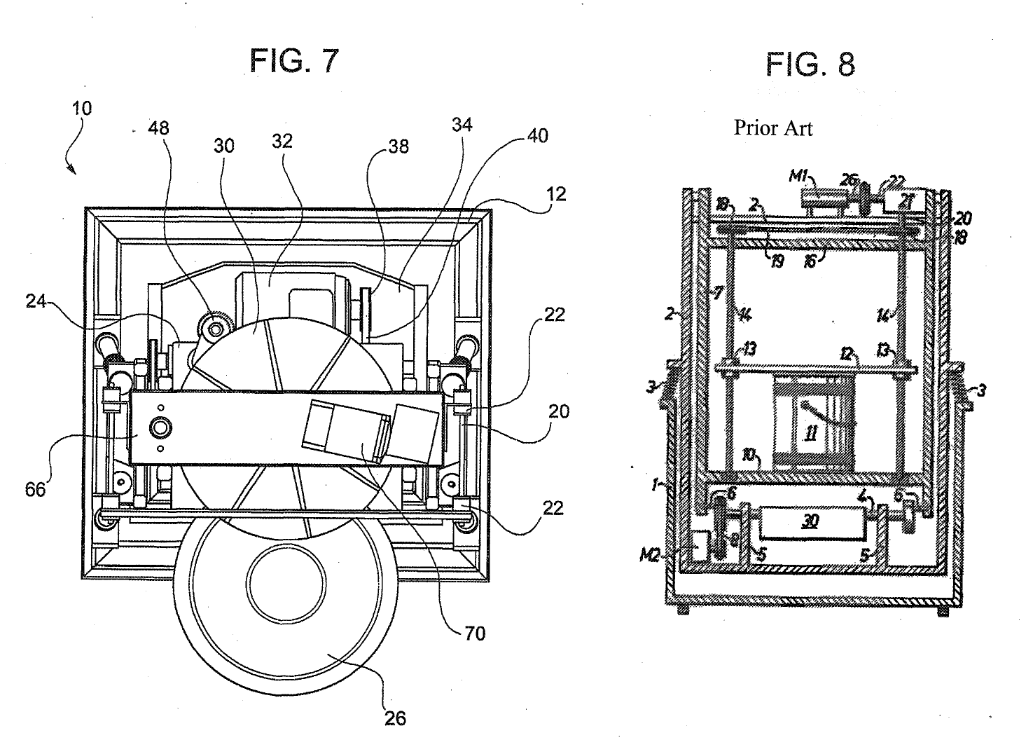

FIG. 7 is a plan view from above of the mixing device of the invention, in the same condition as FIG. 4; and

FIG. 8 is a front elevation view of a mixing device known from U.S. Pat. No. 4,134,689.

With reference to FIGS. 1 to 7, a mixing device for mixing or amalgamating products in liquid, granular or powder form, such as paints, seeds and the like, is generally indicated 10 and comprises a base 12, an outer frame 14 supported on the base 12 by means of four suspension devices, each formed for instance by a vibration-damping cylinder 16 and by a spring 17 wound around a rod of the cylinder 16, and an inner frame 18 housed within the outer frame 14 and connected at its top to this latter by means of a pair of rods 20 provided with anti-vibration devices 22, such as for instance rubber bushes. Advantageously, the rubber bushes 22 act as members for articulation of the rods 20 to the outer frame 14 and to the inner frame 18.

The inner frame 18 carries a vertically fixed support structure 24, on which a lower support plate 26 is rotatably mounted, and a vertically movable cross-member 28, on which an upper clamping plate 30 is mounted coaxially to the inner plate. The two plates 26 and 30 perform in per-se-known way the function to clamp a receptacle or can C containing the product to be mixed. According to the invention, the two plates 26 and 30 are both rotatably mounted about a common vertical axis, indicated Z in FIG. 3, in such a manner that the receptacle or can C can also be caused to rotate about the vertical axis Z, generally coincident with its own axis of symmetry, in order to enhance the mixing action, as will be described in greater detail further on.

The mixing device according to the invention is thus able to impart a rotational movement about a vertical axis to the receptacle or can C, in addition to the usual vertical oscillation movement. Both the vertical oscillation movement and the rotational movement of the receptacle or can C are driven by a motor 32, preferably an electric motor, through a mechanism for driving the mixing movement which will be now described in detail.

The electric motor 32 is mounted on a bottom 34 of the outer frame 14, either on the rear side (as in the illustrated example) or on the front side. On the other hand, a counterweight 36 is mounted on the opposite of the bottom 34 of the outer frame 14. The electric motor 32 controls the rotation of a driving pulley 38, which is connected to a driven pulley 42 carried by an eccentric shaft 44 (FIG. 3) through a flexible transmission member 40, such as a belt.

The eccentric shaft 44 is supported on the bottom 34 of the outer frame 14 by means of a pair of bearings 43 so as to be able to rotate about a horizontal axis X, and is provided at its opposite ends with a pair of eccentric pins 45, which are offset with respect to the horizontal axis X and are operatively associated to the inner frame 18. Specifically, in the illustrated embodiment the eccentric pins 45 are each arranged within a respective guide slit 47 (FIG. 1) provided in a side wall of the support structure 24. Moreover, the eccentric shaft 44 preferably carries at least one eccentric mass, in the illustrated example a pair of eccentric masses 46 which are arranged at the opposite ends of the shaft 44 and carry the eccentric pins 45. Alternatively, the eccentric mass could be a single mass arranged in the middle portion of the eccentric shaft 44, as in the above-discussed prior art example.

Accordingly, when the electric motor 32 is activated the eccentric shaft 44 is set into rotation about the horizontal axis X and imparts to the inner frame 18, and therefore to the receptacle or can C carried thereon, a vertical oscillation movement along an approximately oval or elliptic path by means of the eccentric pins 45.

A driving wheel 48 arranged to drive the rotation of the lower support plate 26 is rotatably mounted on the support structure 24. In the illustrated embodiment, the driving wheel 48 is made as a friction wheel and is arranged with its side surface in contact with the side surface of the lower support plate 26. The friction wheel 48 is mounted at the upper end of a vertical shaft 50 supported by the support structure 24 and is driven, for example through a gear 51, by a horizontal bevel gear 52 also supported by the support structure 24. The horizontal bevel gear 52 permanently meshes with a vertical bevel gear 54 integral for rotation with a driven pulley 56, the vertical bevel gear and the pulley being both supported by the support structure 24. The driven pulley 56 is connected to a driving pulley 58, also supported by the support structure 24, through a flexible transmission member, such as a belt 60. The driving pulley 58 is driven by the eccentric shaft 44, being it for example mounted on one of the two eccentric pins 45, as can be seen in FIG. 5. Therefore, when the electric motor 32 is activated and sets the driven pulley 42 into rotation, also the friction wheel 48 and the lower support plate 26 are set into rotation by the mechanism consisting of the driving pulley 58, the belt 60, the driven pulley 56 and the two bevel gears 52 and 54.

The receptacle or can C arranged on the lower support plate 26 is thus subjected to both a vertical oscillation movement and a rotational movement about the vertical axis Z, which allows greatly to enhance the effectiveness of the mixing action compared with a conventional device in which only the vertical oscillation movement is provided.

According to a variant embodiment (not illustrated), a clutch, preferably an electromagnetic clutch, is associated to the driving pulley 58, and by means of this clutch the pulley can selectively be rotationally coupled with or uncoupled from the driven pulley 42 controlled by the electric motor 32. In this way, the user of the device can choose between a first mode of operation, in which the clutch is disengaged and therefore no rotational movement is imparted to the receptacle or can C, and a second mode of operation, in which the clutch is engaged and therefore the receptacle or can C is subjected at the same time to the vertical oscillation movement and to the rotational movement about the axis Z.

As far as the clamping of the receptacle or can C is concerned, the vertical movement of the cross-member 28 carrying the upper clamping plate 30 is driven by a mechanism similar to the one previously described with reference to the prior art. Also in this case, in fact, a pair of nut screws 62 are securely connected to the cross-member 28 and mesh with respective screws 64 rotatably supported at their upper ends by an upper plate 66 of the inner frame 18 and at their lower ends by the support structure 24. Respective pulleys 68 (FIG. 3), one of which is driven by a second electric motor 70 mounted on the upper plate 66 and is connected to the other pulley 68 by means of a flexible transmission member, such as a belt (not shown), are attached to the upper ends of the worms 64.

As mentioned in the introductory part of the description, according to a further aspect of the invention the lower support plate 26 is mounted on the support structure 24 in such a manner that it can slide horizontally in the front-to-rear direction of the mixing device 10 between a normal retracted position, to which in particular FIG. 1 to 3 refer, and an extended loading/unloading position, to which FIGS. 4 to 7 refer. In this connection, the lower support plate 26 is mounted on a movable portion 71 of the support structure 24, which is provided with guide members, such as for example a pair of guide rods 72 slidably arranged within respective guide bodies 74 attached to the support structure 24. The movable portion 71 of the support structure 24 is also provided with a manual locking member 76 (FIGS. 4 and 5) for locking the movable portion 71 in the normal retracted position. In this way, in order to load or unload a receptacle or can C the user can pull out the movable portion 71 of the support structure 24 and then easily place the receptacle or can on the lower support plate 26 or easily remove the receptacle or can from the lower support plate 26.

Naturally, the principle of the invention remaining unchanged, the embodiments and details of construction can widely vary from those described and illustrated purely by way of non-limiting example.

1. Mixing device for mixing or amalgamating products in liquid, granular or powder form, such as paints, seeds and the like, comprising a first motor and first driving means operated by said first motor to impart a vertical oscillation movement to a receptacle containing the product to be mixed,
second driving means arranged to impart a rotational movement about a vertical axis to the receptacle at the same time as the vertical oscillation movement, said second driving means being operated by said first motor.

2. Mixing device according to claim 1, comprising a substantially stationary outer frame and a movable inner frame supported by the outer frame, wherein the inner frame is provided with a lower support plate, on which the receptacle is arranged, and with an upper clamping plate, which can be moved towards the inner plate to clamp the receptacle, the lower and upper plates being both rotatably mounted about the vertical axis.

3. Mixing device according to claim 2, wherein the first driving means comprise an eccentric shaft, which is supported by the outer frame to rotate about a horizontal axis and is provided at its opposite ends with a pair of eccentric pins operatively associated to the inner frame, and first transmission means for transmitting the rotary motion outputted from the first motor to the eccentric shaft.

4. Mixing device according to claim 3, wherein the first transmission means include a first driving pulley arranged to be driven by the first motor, a first driven pulley integral for rotation with the eccentric shaft and a first flexible transmission member which operatively connects the first driving pulley to the first driven pulley.

5. Mixing device according to claim 3, wherein the eccentric shaft carries a pair of eccentric masses, to each of which a respective eccentric pin is secured.

6. Mixing device according to claim 2, wherein the second driving means comprise a driving wheel arranged to set the lower support plate into rotation and second transmission means for transmitting the rotary motion outputted from the first motor to the driving wheel.

7. Mixing device according to claim 3, wherein the second transmission means are interposed between the driving wheel and the eccentric shaft.

8. Mixing device according to claim 7, wherein the second transmission means include a second driving pulley integral for rotation with the eccentric shaft, a second driven pulley, a second flexible transmission member which operatively connects the second driving pulley to the second driven pulley, a first bevel gear integral for rotation with the second driven pulley and a second bevel gear permanently meshing with the first bevel gear (54) and connected for rotation with the driving wheel.

9. Mixing device according to claim 6, wherein the driving wheel is a friction wheel arranged with a side surface thereof in contact with a side surface of the lower support plate.

10. Mixing device according to claim 1, wherein the second driving means comprise a clutch by which the second driving means can be alternatively coupled with or uncoupled from the first motor.

11. Mixing device according to claim 8, wherein the clutch is associated to the second driving pulley and is arranged to couple the second driving pulley for rotation with the eccentric shaft or uncouple the second driving pulley for rotation from the eccentric shaft.

12. Mixing device according to claim 10, wherein the clutch is an electromagnetic clutch.

13. Mixing device according to claim 2, wherein the inner frame carries a vertically movable cross-member on which the upper camping plate is mounted, a second motor and a motion converting mechanism for converting the rotary motion outputted from the motor into the translational motion of the cross-member.

14. Mixing device according to claim 2, wherein the lower support plate is mounted on the inner frame so as to be able to slide horizontally between a normal retracted position, in which the lower support plate is arranged substantially coaxially to the upper clamping plate, and a loading/unloading extended position, in which the lower support plate projects from the mixing device to enable loading and unloading of the receptacle.

15. Mixing device according to claim 14, wherein the inner frame carries a support structure including a movable portion on which the lower support plate is mounted, the movable portion and the support structure being provided with guide means for guiding the sliding movement of the lower support plate between the retracted and extended positions.

16. Mixing device according to claim 15, wherein said guide means comprise a pair of guide rods secured to the movable portion and a pair of guide bodies carried by the support structure, in which guide bodies the guide rods are slidably arranged.

17. Mixing device according to claim 2, further comprising a base on which the outer frame is supported and suspension means interposed between the base and the outer frame.

18. Mixing device according to claim 17, wherein said suspension means include a plurality of suspension devices each comprising a vibration-damping cylinder and a spring wound around a rod of the cylinder.

19. Mixing device according to claim 2, wherein the inner frame and the outer frame are connected to each other at their upper portions by of rods articulated at their ends to the inner frame and to the outer frame by of rubber bushes.
